(19) United States
(12) Patent Application Publication
(10) Pub. No.: US 2013/0253080 A1
(43) Pub. Date: Sep. 26, 2013

(54) METHOD FOR PREPARING A SULFONATED POLYARYLENE ETHER SULFONE COPOLYMER FOR FUEL CELLS

(71) Applicants: Mi Soon LEE, Daejeon (KR); Young Woo Choi, Cheongju-si (KR); Tae Hyun Yang, Daejeon (KR); Chang Soo Kim, Incheon (KR); Young Gi Yoon, Daejeon (KR); Seok Hee Park, Daejeon (KR); Sung Dae Yim, Daejeon (KR); Gu Gon Park, Daejeon (KR); Young Jun Sohn, Daejeon (KR); Minjin Kim, Daejeon (KR); Byungchan Bae, Seoul (KR)

(72) Inventors: Mi Soon LEE, Daejeon (KR); Young Woo Choi, Cheongju-si (KR); Tae Hyun Yang, Daejeon (KR); Chang Soo Kim, Incheon (KR); Young Gi Yoon, Daejeon (KR); Seok Hee Park, Daejeon (KR); Sung Dae Yim, Daejeon (KR); Gu Gon Park, Daejeon (KR); Young Jun Sohn, Daejeon (KR); Minjin Kim, Daejeon (KR); Byungchan Bae, Seoul (KR)

(21) Appl. No.: 13/588,089

(22) Filed: Aug. 17, 2012

(30) Foreign Application Priority Data
Mar. 20, 2012 (KR) 10-2012-0028194

(51) Int. Cl. C08G 75/23; B01J 41/12

(52) U.S. Cl. 521/25

(57) ABSTRACT

The present disclosure relates to a method for preparing sulfonated polyarylene ether sulfone copolymer used in fabricating an electrolyte polymer membrane which is core material, the method comprising: A) mixing monomers, 4,4′-dihydroxydiphenyl; bis(4-chlorophenyl)sulfone or bis(4-fluorophenyl)sulfone; and 3,3′-disulfonated-4,4′-chlorodiphenyl sulfone with K₂CO₃; B) dissolving said mixture in a reaction solvent, i.e. N,N-Dimethylacetamide; C) reacting said dissolved mixture for 16˜20 hours at a temperature of 160˜190° C.; and D) precipitating, cleaning and filtering, and then drying said reactant.

### CROSS-REFERENCE TO RELATED APPLICATION

This application claims the benefit of Korean Patent Application No. 10-2012-0028194 filed on Mar. 20, 2012, which is herein incorporated by reference as if fully set forth herein.

### BACKGROUND OF THE INVENTION

The present disclosure generally relates to a method for preparing a sulfonated polyarylene ether sulfone copolymer for fuel cells, and more particularly, to a technique for preparing a sulfonated polyarylene ether sulfone copolymer which is electrolyte polymer used for polymer fuel cells by a simple condensation polymerization method.

The performance of fuel cells is dependent on a property of matter of an electrolyte polymer membrane which is a core material of polymer fuel cells. Conventionally, a membrane has been fabricated by using fluorinated polymers represented by Nafion. However, because of drawbacks of fluorine releasing and high unit cost of the fluorinated polymers, attempts to use hydrocarbon polymers which are environment-friendly materials have been made constantly. As a result of efforts of many researchers, the performance of polymer fuel cells applying a membrane for fuel cells using hydrocarbon polymers has been equivalent to that of polymer fuel cells applying a fluorinated polymer membrane.

However, hydrocarbon polymers applied to fuel cells have been generally prepared in a way that polymers such as a polyarylene ether sulfone or a polyarylene ether ketone of engineering plastics which have an aromatic ether bonding are directly condensed and polymerized by using sulfonated monomers.

This conventional direct condensation polymerization method requires necessarily procedure of deriving an ether bonding between monomers, in particular, toluene or cyclohexane which are azeotrope solvent is used in order to derive dehydration during the procedure. For example, a polyarylene ether sulfone is conventionally prepared by a method as below:

After mixing the refined BP (4.4′-biphenyl sulfone) dichlorodiphenylsulfone (DCDPS), sulfonated dichlorodiphenylsulfone (SDCDPS) and anhydrous K₂CO₃ at a predetermined rate, it was stirred in a mixed solution of N-methyl-2-pyrrolidinone (NMP) and toluene for at least 1 hour or more than 1 hour, and committed monomers were dissolved completely. Subsequently, after removing water which is by-product by refluxing the toluene at a reaction temperature of 130° C. for 4 hours, in turn, raised the temperature to 190° C. and then reacted for 16 hours in a condition that residual toluene was removed completely. When the reaction ended, residual reactants insoluble and salts were removed by diluting and filtering the reaction solution with NMP, and then the filtered reactant solution was poured in pure water and precipitated in a swelled fiber form, and then filtered and separated. Then, the separated reaction product was dried in a decompressed dryer of 120° C. for at least 12 hours or more than 12 hours, finally, SPAES-50 copolymers were prepared by using nucleophilic substitution.' [fabrication and property of a sulfonated polyarylene ether sulfone composite membrane containing TEOS for polymer electrolyte type-fuel cells, membrane Vol. No. 4(December 2010) pp. 280]

However, in using the azeotrope, monomers required for polymerization fall solubility each others, this results in many difficulties in a uniform polymerization, and act as a gigantic problem in a polymerization reproducibility as well.

Therefore, the present inventors studied a method for polymerizing aromatic ether bonded electrolyte polymer having an excellent reproducibility by using a single polymer solvent and process without having an effect on the dehydration procedure which is necessarily required for polymerizing by ether bonding of monomers in order to solve the above problems, thereby devised the present disclosure.

### SUMMARY OF THE INVENTION

The present disclosure provides a method for polymerizing aromatic ether bonded electrolyte polymer having an excellent reproducibility using single polymer solvent and process without having an effect on the dehydration procedure, which is necessarily required for polymerizing by ether bonding of monomers in order to solve the above problems.

According to an aspect of the present disclosure, a method for preparing a sulfonated polyarylene ether sulfone for fuel cells is provided, the method comprises the steps of: A) mixing monomers with K₂CO₃, said monomers being 4,4′-dihydroxydiphenyl; bis(4-chlorophenyl)sulfone or bis(4-fluorophenyl)sulfone; and 3,3′-disulfonated-4,4′-chlorodiphenyl sulfone; B) dissolving said mixture in a reaction solvent, said reaction solvent being N,N-Dimethylacetamide; C) reacting said dissolved mixture for 16˜20 hours at 160˜190° C.; and D) precipitating, cleaning and filtering, and then drying said reactant.

Advantageously, in said step A), said monomers, i.e. 4,4′-dihydroxydiphenyl; bis(4-chlorophenyl)sulfone or bis(4-fluorophenyl)sulfone; and 3,3′-disulfonated-4,4′-chlorodiphenyl sulfone are mixed at 2:1:1 mole rate. In this regard, advantageously, said K₂CO₃ is mixed at 1.5 equivalence rate.

Advantageously, in said step D), said reactant is precipitated in de-ionized water, and cleaned repeatedly, stirred in de-ionized water of 60˜80° C. all night, and then filtered, and dried for 24 hours in an oven of 120° C.

Method of the present disclosure is to preparing polymers without an azeotrope solvent without going through a complex type of condensation polymerization which use by mixing the azeotrope solvent such as conventional toluene and a polymer solvent and under a single polymerization temperature as well, thereby the property of matter of the resulting polymer is excellent and it is prepared at a low cost as well.

### BRIEF DESCRIPTION OF THE DRAWINGS

FIG. 1 is a graph viewing a result of an analysis of ¹H NMR of a polymer prepared according to an embodiment of the present disclosure.

FIG. 2 is a graph viewing a hydrogen ion conductance of the polymer electrolyte membrane comprising a polymer prepared according to an embodiment of the present disclosure.

FIG. 3 is a graph viewing an ion-exchange capacity of the polymer electrolyte membrane comprising a polymer prepared according to an embodiment of the present disclosure.

### DETAILED DESCRIPTION OF THE INVENTION

In the following detailed description, the most desirable embodiments of the present disclosure are described in detail, with reference to attached figures, in order to enable an ordinary person skilled in the art to implement the present disclosure.

According to an embodiment of the present disclosure, a sulfonated polyarylene ether sulfone polymer for fuel cells by using an condensation polymerization reaction as below:

A) mixing monomers, i.e. 4,4′-dihydroxydiphenyl; bis(4-chlorophenyl)sulfone or bis(4-fluorophenyl)sulfone; and 3,3′-disulfonated-4,4′-chlorodiphenyl sulfone with K₂CO₃; B) dissolving said mixture in a reaction solvent, N,N-Dimethylacetamide; C) reacting said dissolved mixture for 16˜20 hours at 160˜190° C.; and D) precipitating, cleaning and filtering, and then drying said reactant.

In particular, monomers, i.e. 4,4′-dihydroxydiphenyl represented by the following formula (I), bis(4-chlorophenyl)sulfone represented by the following formula (II) or bis(4-fluorophenyl)sulfone represented by the following formula (III), and 3,3′-disulfonated-4,4′-chlorodiphenyl sulfone represented by the following formula (IV) is used by mixing at a predetermined rate.

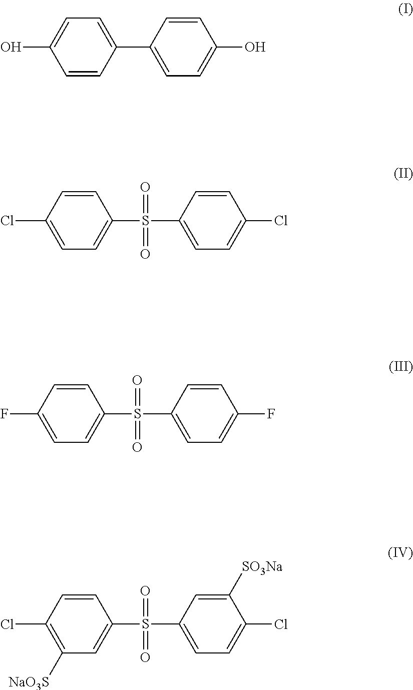

K₂CO₃ is mixed in the mixture, and then the resulting mixture is dissolved in a reaction solvent. Compared with the prior art, in the present disclosure, azeotrope solutions such as toluene or cyclohexane is not used. According to an embodiment of the present disclosure, N,N-dimethlacetamide is used as a single polymerization reaction solvent. The monomer is dissolved, it is reacted to copolymerized for 16˜20 hours at a temperature of 160˜190° C. This preparing process of the present disclosure is simple and reproducibility is excellent since an azeotrope such as toluene is not used. Subsequently, reactants are precipitated, cleaned and filtered, and then dried, thereby the polyarylene ether sulfone copolymer having sulfonic acid group is prepared. In this regard, advantageously, the reactant is precipitated in de-ionized water and cleaned repeatedly, and stirred in de-ionized water of 60˜80° C. all night, and filtered, and then dried in an oven of a temperature of 120° C. for 24 hours.

The sulfonated polyarylene ether sulfone copolymer (SPAES) as represented by following formula (V) is fabricated by the above-mentioned fabricating process.

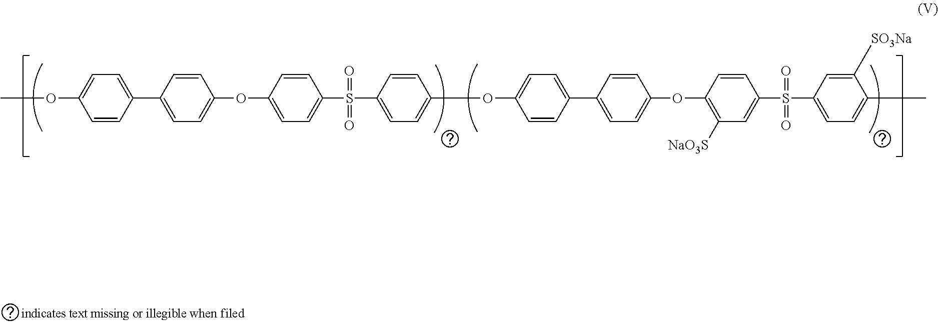

According to an embodiment of the present disclosure, a polymer is prepared by mixing the monomers, i.e. 4,4′-dihydroxydiphenyl, bis(4-chlorophenyl)sulfone and 3,3′-disulfonated-4,4′-chlorodiphenyl sulfone with K₂CO₃ at 2:1:1 mole rate, and mixing the K₂CO₃ at 1.5 equivalence ratio, and dissolving in a reaction solvent, i.e. N,N-Dimethylacetamide. In case of using the above monemors, the reaction step C) is advantageously comprised of refluxing DMAc at a temperature of 180° C. and reacting 16˜20 hours.

According to another embodiment of the present disclosure, a polymer is prepared by mixing the monomers, i.e. 4,4′-dihydroxydiphenyl, bis(4-fluorophenyl)sulfone and 3,3′-disulfonated-4,4′-chlorodiphenyl sulfone with K₂CO₃ at 2:1:1 mole rate, and mixing the K₂CO₃ at 1.5 equivalence ratio, and dissolving in a reaction solvent, N,N-Dimethylacetamide. In case of using the above monemors, the reaction step C) is advantageously comprised of refluxing DMAc at a temperature of 180° C. for 10 minutes and removing water which is by-product produced during the reaction and then reacting at a lowered temperature of 160° C. for 16 hours.

The membrane fabricated with the sulfonated polyarylene ether sulfone copolymer for fuel cells prepared by method of the present disclosure is more excellent than the conventional Nafion on ion conductance or ion exchange capacity, and the membrane is at least the same as or more than the copolymer fabricated by the conventional method in property.

### EXAMPLES

In the following description, though the present disclosure is described with examples and test examples, the scope of the present disclosure is not limited by these description.

### Example 1

### Preparation of a Sulfonated Polyarylene Ether Sulfone Copolymer

Mixed and put monomers, i.e. 4,4′-dihydroxydiphenyl 7.5601 g (40.6 mmol), bis(4-chlorophenyl)sulfone 5.8296 g (20.3 mmol) and 3,3′-disulfonated-4,4′-chlorodiphenyl sulfone 9.9724 g (20.3 mmol) at 2:1:1 mole rate, and K₂CO₃ at 1.5 equivalence rate, a reaction solvent, i.e. N,N-dimethylacetamide 60 ml into a 250 ml round-bottom flask having 3 holes set with Dean stark apparatus connecting a cooling condenser, and then refluxed DMAc at a temperature of 180° C. and reacted for 16-20 hours. Therefore, water which is by-product produced during the reaction can be removed simultaneously with polymerization reaction thereby. After the reaction ended, the reactant was precipitated in de-ionized water, and cleaned repeatedly, stirred in de-ionized water of a temperature of 60˜80° C. all night and filtered, and then dried in an oven of 120° C. for 24 hours, and resulted in preparing of a hydrocarbon copolymer (SPAES50-C1) having sulfonic acid group.

### Example 2

### Preparation of a Sulfonated Polyarylene Ether Sulfone Copolymer

Mixed and put monomers, i.e. 4,4′-dihydroxydiphenyl 7.5601 g (40.6 mmol), bis(4-fluorophenyl)sulfone 5.1623 g (20.3 mmol) and 3,3′-disulfonated-4,4′-chlorodiphenyl sulfone 9.3043 g (20.3 mmol) at 2:1:1 mole rate, and K₂CO₃ at 1.5 equivalence rate, a reaction solvent, i.e. N,N-dimethylacetamide 60 ml into a 250 ml round-bottom flask having 3 holes set with Dean stark apparatus connecting a cooling condenser, and then refluxed DMAc at a temperature of 180° C. for 10 minutes and then removed water which is by-product produced during the reaction, and then reacted at a lowered temperature of 160° C. for 16 hours, and then precipitated in de-ionized water, and cleaned repeatedly, stirred in de-ionized water of a temperature of 60˜80° C. all night and filtered, and then dried in an oven of 120° C. for 24 hours, and resulted in preparing of a hydrocarbon copolymer (SPAES50-F) having sulfonic acid group.

### Comparison Example 1

### Preparation of a Sulfonated Polyarylene Ether Sulfone Copolymer

According to a conventional fabrication method, mixed and put monomers, i.e. 4,4′-dihydroxydiphenyl 7.5601 g (40.6 mmol), bis(4-chlorohenyl)sulfone 5.8296 g (20.3 mmol) and 3,3′-disulfonated-4,4′-chlorodiphenyl sulfone 9.9724 g (20.3 mmol) at 2:1:1 mole rate, and K₂CO₃ at 1.5 equivalence rate, a reaction solvent, i.e. anhydrous 1-Methyl-2-pyrrolidinone 40 ml and an azeotrope solvent, i.e. anhydrous Toluene 30 ml into a 250 ml round-bottom flask having 3 holes set with Dean stark apparatus connecting a cooling condenser, and then refluxed toluene at a temperature of 130˜160° C. for 6˜10 hours to remove water which is by-product produced during the reaction, after this reaction ending, the toluene was removed from a reactor. Subsequently, reacted at a temperature 190˜195° C. for 16˜24 hours, and then precipitated the reactant in de-ionized water and cleaned repeatedly, stirred in de-ionized water of a temperature of 60˜80° C. all night and filtered, and then dried in an oven of 120° C. for 24 hours, and resulted in preparing of a hydrocarbon copolymer (SPAES50-C1) having sulfonic acid group.

### Comparison Example 2

### Preparation of a Sulfonated Polyarylene Ether Sulfone Copolymer

According to an conventional fabrication method, Mixed and put monomers, i.e. 4,4′-dihydroxydiphenyl 7.5601 g (40.6 mmol), bis(4-fluorophenyl)sulfone 5.1623 g (20.3 mmol) and 3,3′-disulfonated-4,4′-chlorodiphenyl sulfone 9.3043 g (20.3 mmol) at 2:1:1 mole rate, and K₂CO₃ at 1.5 equivalence rate, a reaction solvent, i.e. anhydrous N,N-dimethylacetamide 40 ml and an azeotrope solvent anhydrous Toluene 30 ml into a 250 ml round-bottom flask having 3 holes set with Dean stark apparatus connecting a cooling condenser, and then refluxed the Toluene at a temperature of 125˜135° C. for 6 hours to remove water which is by-product produced during the reaction, and after this reaction ending, the Toluene was removed in the reactor. Subsequently, reacted at a temperature of 170˜175° C. for 16 hours, and then precipitated the reactant in de-ionized water, and cleaned repeatedly, stirred in de-ionized water of a temperature of 60˜80° C. all night and filtered, and then dried in an oven of 120° C. for 24 hours, and resulted in preparing of a hydrocarbon copolymer (SPAES50-F) having sulfonic acid group.

### Test Example 1

### Measurement of Degree of Sulfonation

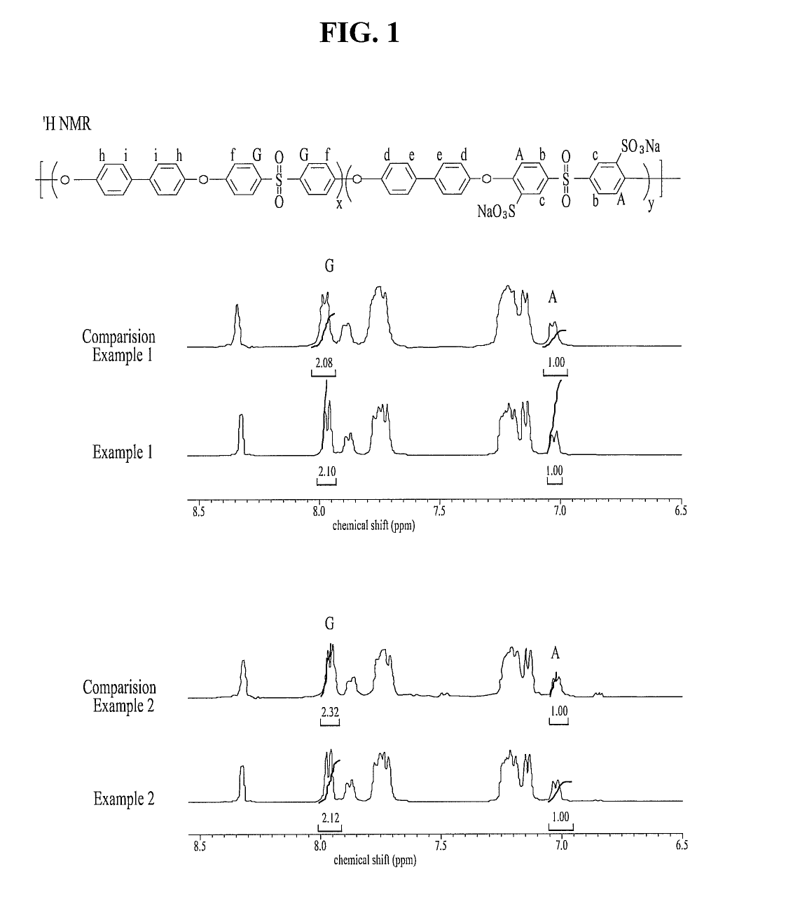

An electrolyte membrane was fabricated with a conventional method while using the copolymer prepared in the above example and comparison example. On the basis of a result of ¹H NMR analysis of the copolymer, the Degree of Sulfonation was calculated. ¹H NMR result of the copolymer is viewed in FIG. 1, the Degree of Sulfonation was calculated with the following equation, thereby the result is represented the following table 1.

Degree of Sulfonation(%)=(A/2)/(A/2+G/4)×100

TABLE 1

| Polymer electrolyte membrane | Degree of Sulfonation (%) |
|---|---|
| Comparison example 1 | 48.78 |
| Example 1 | 48.89 |
| Comparison example 2 | 46.29 |
| Example 2 | 48.54 |

As can be seen the above table 1, the polymers prepared by method according to the present disclosure is similar to those of the conventional method in the Degree of Sulfonation.

### Test Example 2

### Evaluation of Ion Conductance

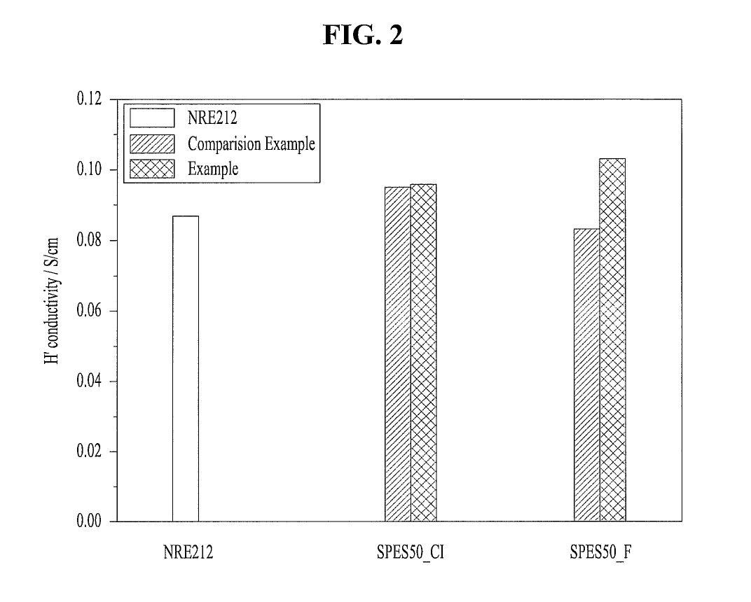

Ion Conductance was evaluated by electrolyte membrane fabricated with the copolymer prepared in the above example and comparison example, the result is represented in the following table 2 and FIG. 2. Nafion 212 polymer electrolyte was used as a contrast example.

TABLE 2

| Polymer electrolyte membrane | Ion Conductance (S/cm) |
|---|---|
| Contrast example (NRE 212) | 0.0867 |
| Comparison example 1 | 0.0949 |
| Example 1 | 0.0957 |
| Comparison 2 | 0.0832 |
| Example 2 | 0.1032 |

As can be seen in the above table 2 and FIG. 2, the polymer electrolyte membranes fabricated with polymer according to example 1, 2 of the present disclosure represent an excellent Hydrogen Ion Conductance.

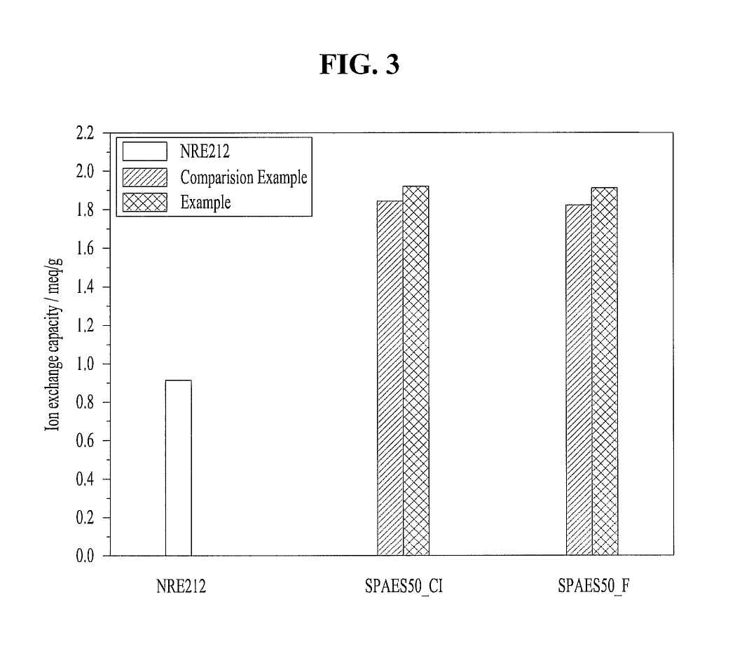

Ion-exchange capacity was evaluated by electrolyte membrane fabricated with the copolymer prepared in the above example and comparison example, the result is represented in the following table 3 and FIG. 3. Nafion 212 polymer electrolyte was used as a contrast example.

TABLE 3

| Polymer electrolyte membrane | Ion-change capacity (meq/g) |
|---|---|
| Contrast example (NRE 212) | 0.9172 |
| Comparison example 1 | 1.8505 |
| Example 1 | 1.9244 |
| Comparison 2 | 1.8264 |
| Example 2 | 1.9118 |

As can be seen in the above table 3 and FIG. 3, the polymer electrolyte membranes fabricated with polymer according to example 1, 2 of the present disclosure represent an excellent Ion-exchange capacity property.

1. A method for preparing a sulfonated polyarylene ether sulfone copolymer for fuel cells, the method comprising:
A) mixing monomers with K₂CO₃, said monomers being 4,4′-dihydroxydiphenyl; bis(4-chlorophenyl)sulfone or bis(4-fluorophenyl)sulfone; and 3,3′-disulfonated-4,4′-chlorodiphenyl sulfone;
B) dissolving said mixture in a reaction solvent, the said reaction solvent being N,N-Dimethylacetamide;
C) reacting said dissolved mixture for 16˜20 hours at a temperature of 160˜190° C.; and
D) precipitating, cleaning and filtering, and then drying said reactant.

2. The method of claim 1, wherein in said step A), said monomers, i.e. 4,4′-dihydroxydiphenyl; bis(4-chlorophenyl)sulfone or bis(4-fluorophenyl)sulfone; and 3,3′-disulfonated-4,4′-chlorodiphenyl sulfone are mixed at 2:1:1 mole rate.

3. The method of claim 1, wherein said K₂CO₃ is mixed at 1.5 equivalence ratio.

4. The method of claim 1, wherein in said step D), said reactant is precipitated in de-ionized water, and cleaned repeatedly, stirred in de-ionized water of 60˜80° C. all night, and subsequently filtered, and dried for 24 hours in an oven of 120° C.

5. The method of claim 1, wherein in case of said Bis(4-chlorophenyl)sulfone is used in said step A), said step C) comprises refluxing DMAc at a temperature of 180° C. and reacting said dissolved mixture for 16˜20 hours.

6. The method of claim 1, wherein, in case of said Bis(4-fluorophenyl)sulfone is used in said step A), said step C) comprises refluxing DMAc for 10 minutes at a temperature of 180° C. and removing by-product produced during said reaction, said by-product being water, and then reacting said dissolved mixture for 16 hours at a temperature of 160° C.
